(19) United States
(12) Patent Application Publication
(10) Pub. No.: US 2026/0095288 A1
(43) Pub. Date: Apr. 2, 2026

(54) METHODS FOR ESTIMATION OF CSI RECONSTRUCTION QUALITY

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Keya Patani, London (GB); Zihao You, Brooklyn, NY (US); Mohamed Salah Ibrahim, Chesterbrook, PA (US); Patrick Tooher, Montreal (CA); Moon IL Lee, Melville, NY (US); Mihaela Beluri, Jericho, NY (US)

(73) Assignee: InterDigital Patent Holdings, Inc., Wilmington, DE (US)

(21) Appl. No.: 18/902,148

(22) Filed: Sep. 30, 2024

(51) Int. Cl. H04L 5/00; H04W 24/08

(52) U.S. Cl. CPC H04L 5/0053; H04W 24/08

(57) ABSTRACT

A wireless transmit/receive unit (WTRU) may comprise a processor configured to receive configuration information that may include a first reconstruction quality (RQ) function and a second RQ function. The processor may determine a channel state information (CSI) based on a plurality of reference signals (RSs), determine a first plurality of RQ indicators for the first RQ function based on the first RQ function, determine a second plurality of RQ indicators for the second RQ function based on the second RQ function, select the first plurality of RQ indicators or the second plurality of RQ indicators based on the CSI vector, determine encoder input indices for each RQ indicator of the selected plurality of RQ indicators, generate an compressed encoder input vector based on the encoder input indices and send the compressed encoder input vector and information relating to the selected plurality of RQ indicators to the network.

### BACKGROUND

Artificial Intelligence/Machine Learning (AI/ML) based channel state information (CSI) compression may be a means to reduce the CSI feedback reporting overhead. The AI/ML-based CSI compression uses a two-sided autoencoder (AE) model, where the encoder part may be located at the transmitter (e.g., WTRU) side and compresses the high dimensionality input data (e.g., CSI) to a lower dimensionality latent vector; the decoder part may be located at the receiver (e.g., network (NW)) side and performs the reconstruction based on the received latent vector (e.g., compressed CSI).

The quality of the CSI feedback is critical in ensuring good end-to-end system performance. For AI/ML based CSI compression feedback, it may be necessary to monitor the encoder model performance (e.g., to determine whether model fine-tuning or switching is needed), or whether to fallback to non-AI/ML based CSI reporting. The analysis to determine whether model fine-tuning or switching is needed or whether to fallback to non-AI/ML based CSI reporting may require determining the quality of the reconstructed CSI, or equivalently, determining the reconstruction error.

The approaches to estimate the reconstruction error for AE-based compression may include transmitter (e.g., encoder) side methods, and receiver (e.g., decoder) side methods. Transmitter side methods may require the transmitter to support a proxy decoder, which may reconstruct the compressed latent vector. The transmitter-side may measure the reconstruction error (e.g., squared generalized cosine similarity (SGCS) or normalized mean-square error (NMSE)) between the data at the proxy decoder output and the data at the encoder input, and may signal the reconstruction error to the receiver side. If the proxy decoder residing at the transmitter side does not match the actual decoder residing at the receiver side, it may be possible that the reconstruction error determined at the transmitter side does not correctly reflect the actual reconstruction error. This method may require the transmitter to run both the encoder model (e.g., for compression) and the proxy decoder model (e.g., for reconstruction), which may increase the computational complexity and may negatively impact the power consumption.

Receiver side methods require the ground truth to be known at the receiver. Receiver side methods may accurately determine the reconstruction error and thus the reconstruction quality (RQ), and receiver side methods may significantly increase the signaling overhead since the ground truth (e.g., data at the encoder input) needs to be signaled from the transmitter side to the receiver side.

Methods to estimate the reconstruction quality (RQ) at the receiver side with none or minimal additional overhead, and/or without the need for the transmitter and/or encoder to report the ground truth, may be implemented.

### SUMMARY

A wireless transmit/receive unit (WTRU) may comprise a processor. The processor may be configured to receive configuration information. The configuration information may include, for example, a first reconstruction quality (RQ) function and a second RQ function. The processor may be configured to determine channel state information (CSI) based on a plurality of reference signals (RSs). CSI may be, for example, a vector, matrix and/or tensor. The processor may be configured to determine a first plurality of RQ indicators for the first RQ function based on the first RQ function. The processor may be configured to determine a second plurality of RQ indicators for the second RQ function based on the second RQ function. The processor may be configured to select the first plurality of RQ indicators or the second plurality of RQ indicators based on the CSI vector. The processor may be configured to determine encoder input indices for each RQ indicator of the selected plurality of RQ indicators. The processor may be configured to generate a compressed encoder input vector based on the determined encoder input indices. The generation of the compressed encoder input vector may be based on the determined encoder input indices, the selected plurality of RQ indicators, and/or CSI. The compressed value may be reported to the network. The processor may be configured to send the compressed encoder input vector and information relating to the selected plurality of RQ indicators to the network. Information relating to the selected plurality of RQ indicators may be, for example, selected RQ function, determined number of RQ indicators, and/or determined encoder input indices for the RQ indicators.

The configuration information may include, for example, an indication of a number of RQ indicators. The processor may be configured to select the first plurality of RQ indicators or the second plurality of RQ indicators based on the number of RQ indicators indicated by the configuration information.

The indication of the number of RQ indicators may include, for example, a fixed number. The indication of the number of RQ indicators may include, for example, an indication that the WTRU is to determine the number of RQ indicators based on a quality of a channel or based on a statistical property of channel state information (CSI) associated with downlink reference signals (RSs).

The configuration information may include, for example, information associated with the encoder input indices. The processor may be configured to determine encoder input indices based on the information associated with the encoder input indices.

The information associated with the encoder input indices may include, for example, fixed encoder input indices. The information associated with the encoder input indices may include, for example, an indication that the WTRU is to determine the encoder input indices. The compressed encoder input vector may include, for example, the CSI and one or more RQ indicators.

The configuration information may include, for example, one or more of a fixed number of RQ indicators, a reporting periodicity for the RQ indicators, and/or a compression mode. The compression may be determined based on whether CSI is compressed, or CSI and RQ indicators are compressed. The RQ function may include, for example, a set of linear combinations of measured CSI values.

A WTRU may be configured to perform a method that includes one or more of the following steps. The method may include receiving configuration information. The configuration information may include, for example, a first reconstruction quality (RQ) function and a second RQ function. The method may include determining channel state information (CSI) based on a plurality of reference signals (RSs). CSI may be in the form of, for example, a vector, matrix and/or tensor. The method may include determining a first plurality of RQ indicators for the first RQ function based on the first RQ function. The method may include determining a second plurality of RQ indicators for the second RQ function based on the second RQ function. The method may include selecting the first plurality of RQ indicators or the second plurality of RQ indicators based on the CSI vector. The method may include determining encoder input indices for each RQ indicator of the selected plurality of RQ indicators. The method may include generating a compressed encoder input vector based on the determined encoder input indices. The generation of the compressed encoder input vector may be based on the determined encoder input indices, the selected plurality of RQ indicators, and/or CSI. The compressed value may be reported to the network. The method may include sending the compressed encoder input vector and information relating to the selected plurality of RQ indicators to the network. Information relating to the selected plurality of RQ indicators may be, for example, selected RQ function, determined number of RQ indicators, and/or determined encoder input indices for the RQ indicators.

The configuration information may include, for example, an indication of a number of RQ indicators. The method may include selecting the first plurality of RQ indicators or the second plurality of RQ indicators based on the number of RQ indicators indicated by the configuration information.

The indication of the number of RQ indicators may include, for example, a fixed number. The indication of the number of RQ indicators may include, for example, an indication that the method comprises determining the number of RQ indicators based on a quality of a channel or based on a statistical property of channel state information (CSI) associated with downlink reference signals (RSs).

The configuration information may include, for example, information associated with the encoder input indices. The method may include determining encoder input indices based on the information associated with the encoder input indices.

The information associated with the encoder input indices may include, for example, fixed encoder input indices. The information associated with the encoder input indices may include, for example, an indication that the method comprises determining the encoder input indices. The compressed encoder input vector may include, for example, the CSI and one or more RQ indicators.

The configuration information may include, for example, one or more of a fixed number of RQ indicators, a reporting periodicity for the RQ indicators, and/or a compression mode. The compression may be determined based on whether CSI is compressed, or CSI and RQ indicators are compressed. The RQ function may include, for example, a set of linear combinations of measured CSI values.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of joint compression of the input CSI and the determined RQ indicators for estimating the CSI reconstruction quality at the receive-side according to an embodiment.

FIG. 3 is a flowchart illustrating an example procedure for estimation of CSI RQ according to an embodiment.

FIG. 4 is a flowchart illustrating an example procedure for estimation of CSI RQ at the receiving node according to an embodiment.

### DETAILED DESCRIPTION

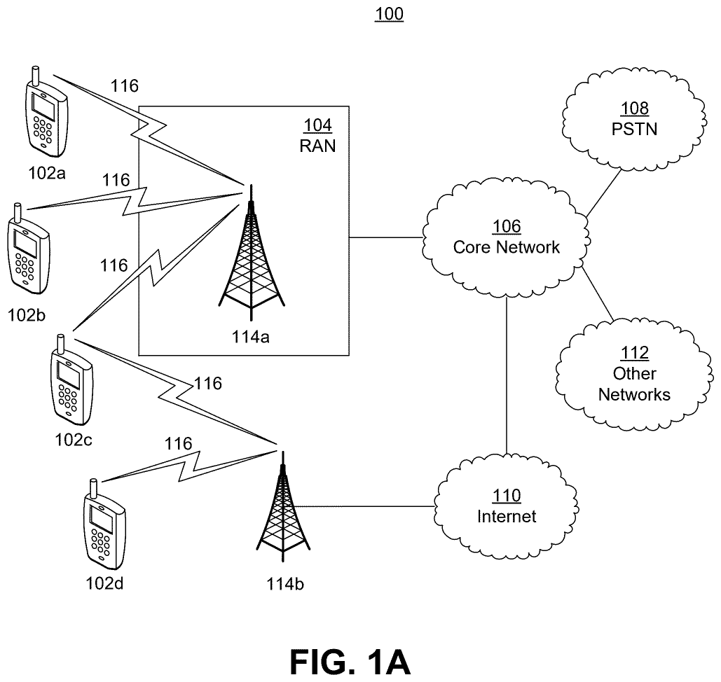

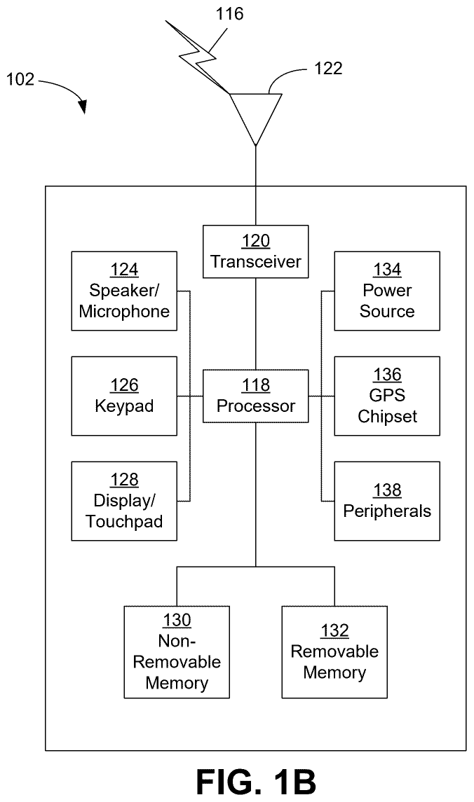

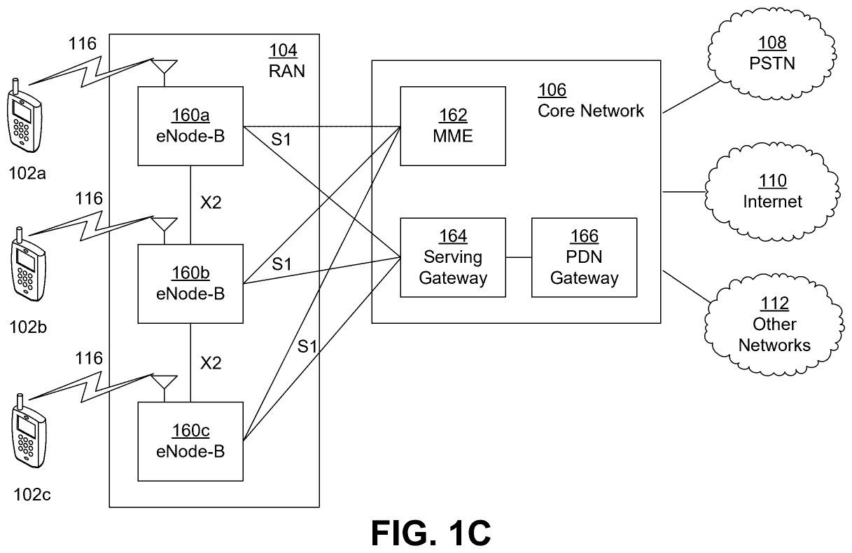

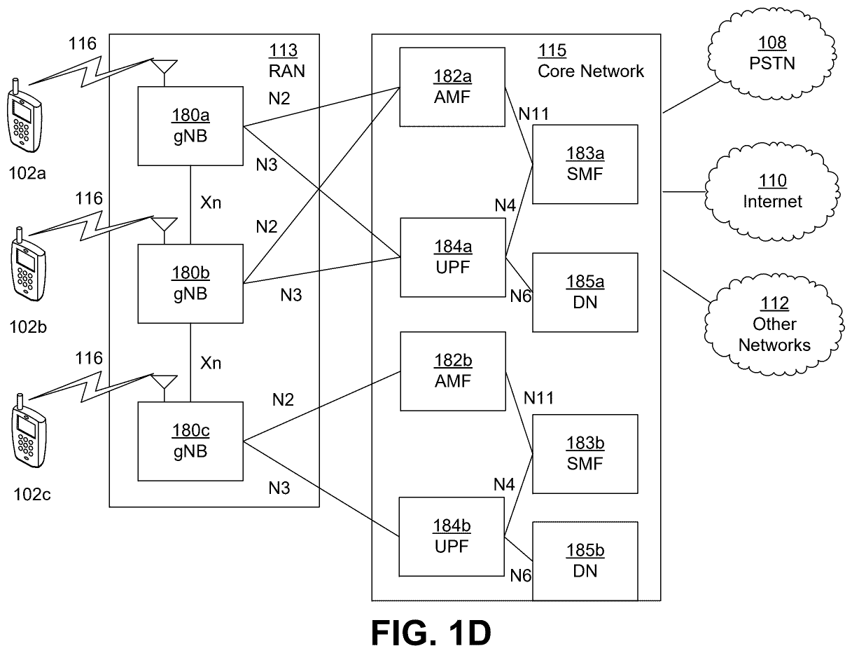

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may compute reconstruction quality (RQ) indicators for CSI based on a determined RQ function and number of RQ indicators. A WTRU may determine input indices for RQ indicators and may compress the CSI and RQ indicators jointly. The WTRU may report compressed CSI and RQ indicators, and the parameters of the determined RQ indicators.

In some examples, the WTRU may be configured with one or more parameters associated with the estimation of CSI reconstruction quality, where the configuration may include one or more of the following. For example, the configuration may include a number of RQ indicators (e.g., fixed number of RQ indicators). The WTRU may determine and/or report the number of RQ indicators. The configuration may include one or more RQ function(s) to compute CSI RQ indicators based on the measured CSI values (e.g., indication of a single function to compute the RQ indicators and/or indication to select and report a function from a set of configured functions). The configuration may include input indices of RQ indicators. For instance, the input indices of RQ indicators may include exact indices of the RQ indicators within the encoder input vector (e.g., input indices), where the encoder input vector may be composed of a CSI input vector possibly multiplexed with a set of one or more RQ indicator(s). The WTRU may determine and report the input indices. The configuration may include reporting periodicity for the RQ indicator (e.g., every N reporting). The configuration may include resources to report the compressed CSI, RQ indicators and/or input indices. The configuration may include compression mode, where the mode may determine whether only CSI or CSI & RQ indicators are compressed.

In some examples, the WTRU may receive reference signals to measure and/or predict the input CSI vector. In some examples, the WTRU may determine the number of RQ indicators based on one of the following. For example, the WTRU may determine the number of RQ indicators based on the configuration from the NW. If configured by the NW to determine and report the number of RQ indicators, the WTRU may determine the number of RQ indicators based on the channel quality, where the WTRU may select a higher number of RQ indicators for low signal-to-noise ratio (SNR). If configured by the NW to determine and report the number of RQ indicators, the WTRU may determine the number of RQ indicators based on the statistical properties of the CSI, where the WTRU may select a higher number of RQ indicators if the current CSI is out of distribution (OOD). The WTRU may truncate and/or down sample the input CSI vector X based on the determined number of RQ indicators.

In some examples, the WTRU may compute a set of RQ indicators per RQ function, using the one or more RQ function(s), and may select a set of RQ indicators and associated RQ function. For instance, the selection of a set of RQ indicators and associated RQ function may be based on the determined number of RQ indicators and the configured single function to determine the RQ indicators. The selection of a set of RQ indicators and associated RQ function may be based on the determined number of RQ indicators and the configured set of functions to determine the RQ indicators. The selection of a set of RQ indicators and associated RQ function may be based on preserving the statistical properties of input CSI vector (e.g., the set of RQ indicators are in-distribution and/or the set of RQ indicators are within the range of input CSI vector elements). If the WTRU is configured with fixed input indices for the set of RQ indicators (e.g., within the input vector of the encoder), the WTRU may select the RQ function such that set of RQ indicators may not cause discontinuity and/or significant discontinuity at the encoder input.

In some examples, the WTRU may determine the encoder input indices of each RQ indicator. For example, the WTRU may determine the input indices based on the configuration from the NW (e.g., fixed input indices configured by the NW). If the WTRU is configured with a RQ function, the WTRU may determine the input indices for RQ indicators (e.g., so that the encoder input vector preserves continuity). In some examples, if the WTRU is configured with a set of RQ functions and configured to determine the encoder input vector indices, the WTRU may jointly select RQ function and RQ indicators encoder input vector indices (e.g., so that the encoder input vector preserves continuity).

In some examples, the WTRU may compress the encoder input vector. In some examples, the encoder input vector consists of only the input CSI vector. In some examples, the encoder input vector consists of the input CSI vector and one or more RQ indicators.

In some examples, the WTRU may report one or more of the compressed encoder input vector and/or the information on the RQ indicators. For example, the WTRU may report the uncompressed RQ indicators. For example, the WTRU may report an indication that the encoder input vector consists of only the input CSI vector, and/or consists of input CSI vector and one or more RQ indicators. For example, the WTRU may report a RQ indicator parameter. For instance, the WTRU may report the number of RQ indicators, RQ function, and/or the encoder input vector indices of the RQ indicators.

Estimation of CSI reconstruction quality at the receiving node (e.g., WTRU or NW) may be implemented. For example, the receiving node may decompress the received compressed encoder input vector and may determine a reconstructed output CSI vector and reconstructed RQ indicators. The receiving node may compare the reconstructed RQ indicators (Y′) with the receiver-side RQ indicators created using the reconstructed output CSI vector, X′, and the known RQ function (e.g., F(X′)). The receiving node may determine the reconstructed quality based on a comparison (e.g., via computing a distance metric Dist (Y′,F(X′)). The receiving node may transmit an indication based on the determined reconstruction quality. For example, the receiving node may transmit an indication to fallback to non-AI/ML reporting in case the quality below threshold. The receiving node may transmit an indication to increase payload size of compressed encoder input vector in case the quality is below a threshold.

In some examples, the receiver may estimate the CSI reconstruction quality with minimal overhead (e.g., without the need for the transmitter and/or encoder to report the ground truth).

To estimate the reconstruction error (or the reconstruction quality) for payload data X input to a lossy communication channel, the transmitter node (e.g., WTRU) may first calculate a set of redundancy elements Y as a function of the input payload (e.g., Y=F(X)) and may pass both the payload X and the redundancy elements Y through the lossy communication channel. The communication channel may be an autoencoder model (e.g., for compressing the data, such as CSI, at the transmit-side, and restoring it at the receive-side). In other examples, the communication channel may be linear or non-linear processing at a transmit-side, followed by transmission over a propagation channel and processing at a receive-side.

In some examples, the input payload X may be a vector and/or matrix of real or complex valued elements. For example, for CSI compression, the input payload X may consist of either the complex raw channel matrix, and/or the complex eigenvectors of the estimated channel matrix.

In some examples, to reduce the overhead, the size of the calculated redundancy Y may be smaller (e.g., much smaller) than the size of the input payload data X. For example, when the payload consists of estimated raw channel matrix, for a configuration of Nᵣ=4 receive antennas, Nₜ=32 transmit antennas and N_{c}=26 sub-bands, the input payload data X size is Nᵣ. Nₜ. N_{c}=3328. In this example, the size of the redundancy Y may be 24. In some examples, the function F(.) may be a linear transformation F(X)=AX, where A is a real or complex-valued matrix. For example, the numerical example described above, the size of the A matrix is 24×3328.

The function F(.) may be known both at the encoder and the decoder side. The redundancy elements may be referred to as reconstruction quality (RQ) indicators. The function F(.) may be referred to as the reconstruction quality (RQ) function.

The receiver node (e.g., the NW) may calculate a distance function between the reconstructed redundancy, Y′, and the receive-side redundancy F(X′) corresponding to the reconstructed payload, X′, as Dist (Y′,F(X′)). The Dist function may be any distance, normalized distance and/or similarity function. The receiver node (e.g., NW) may estimate the reconstruction error of the payload, Dist (X′,X), and thus the reconstruction quality, based on the previously calculated distance, Dist (Y′,F(X′)).

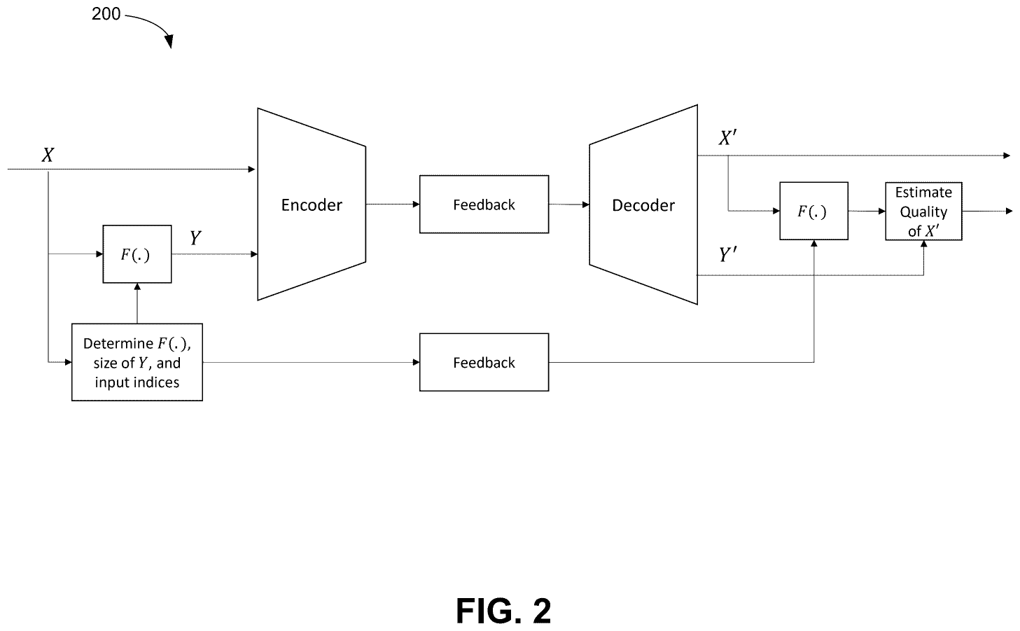

FIG. 2 illustrates a CSI compression example. For instance, diagram 200 illustrates a block diagram of the joint compression of the payload data X (e.g., input CSI) and the calculated RQ indicators (e.g., Y=F(X)) to enable estimating the CSI reconstruction quality at the receive-side.

In some examples, reconstruction quality (RQ) indicators may be a set of elements (e.g., redundancy elements) calculated at the transmit-side as a function of an input payload and/or signaled to a receiver to enable the estimation of the quality of the reconstructed payload at the receive-side. The reconstruction quality indicators may consist of real or complex numbers (e.g., floating-point), for example when the input payload consists of real or complex numbers. A reconstruction quality (RQ) function may be a function that determines the RQ indicators (e.g., redundancy elements) corresponding to an input payload (vector or matrix). RQ indicators input indices may be the location of the RQ indicator elements within the data input to the lossy communication channel. For example, for CSI compression applications, the CSI input payload may be reshaped as a vector, and the input vector payload and the RQ indicators may be applied to the autoencoder input. In some examples, the RQ indicator input indices may be the indices of the RQ elements within the vector at the encoder input. Elements may refer to the individual entries in a vector (e.g., vector elements).

Configurations on CSI RQ indicators may be implemented. In some examples, a WTRU may be configured and/or indicated to compute CSI RQ indicators and determine related parameters. A WTRU may be configured and/or indicated to report RQ indicators together with CSI, for example, to enable estimation of reconstructed CSI quality at the receiver-side.

The configuration may include, for example, the number of reconstruction quality indicators. The configuration may include functions to compute RQ indicators and/or indices of RQ indicators in the encoder input vector. The configuration may include reporting periodicity for the RQ indicators. The configuration may include resources to report CSI. The configuration may include RQ indicators and parameters. The configuration may include receiver-side reference decoder and loss function to be used for training a WTRU-side encoder.

In some examples, the WTRU may receive configuration on the number of RQ indicators where the configuration may include the following. For example, the configuration may include fixed (e.g., NW-configured) number of RQ indicators. The WTRU may be provided with the number of RQ indicators to be computed and reported to the receiver-side (e.g., NW, and/or a WTRU). The configuration may include an indication to determine the number of RQ indicators (e.g., WTRU-determined). The WTRU may be configured to determine number of RQ indicators based on a condition (e.g., channel condition, WTRU speed, etc.) When configured to determine the number of RQ indicators, the WTRU may report the determined number of RQ indicators to the receiver-side.

In some examples, the WTRU may receive configuration for the functions to compute the RQ indicators based on the measured CSI where the configuration may include the following. For example, the configuration may include a single RQ function. The WTRU may be configured with a single RQ function to compute the RQ indicators based on the measured CSI. The function may also depend on the configured and/or determined number of RQ indicators. For instance, a function may represent a set of linear combinations of measured CSI values, so that Y=AX, where matrix A of size m×N represents the set of linear combinations, X vector of size N represents the CSI values, and Y vector of size m represents the reconstruction quality indicators. The configuration may include a set of RQ functions. The WTRU may be configured with a set of functions (e.g., one or more functions) to compute the RQ indicators based the measured CSI. The WTRU may have the capability to support a set of pre-defined functions, and the WTRU may be configured with a subset of the pre-defined functions. In some examples, the WTRU may be configured with a specific set of RQ functions to use for the computation of RQ indicators by the receive-side. For example, each function may represent a different set of linear combinations of measured CSI values, so that different linear combination matrices A₁, . . . , Aₚ may be configured at the WTRU. If the WTRU is configured with more than one RQ functions, then WTRU may select and report an index for the selected RQ function.

In some examples, the WTRU may receive configurations on the index of the reconstruction quality indicators within the encoder input vector (e.g., input indices) where the configuration may include the following. For example, the configuration may include a list of input indices (e.g., NW-configured). The WTRU may be configured with the exact input indices of the RQ indicators within the input vector of the encoder. The configuration may include the start-end indices and/or the indices of RQ indicators separately. For example, the configuration may include an indication to determine the input indices (e.g., WTRU-determined indices within the encoder input vector). The WTRU may be configured to determine and report the input indices for the RQ indicators. The WTRU may determine the input indices for the RQ indicators based on the measured CSI values. For example, the configuration may include mapping order for the RQ indicator(s) within the configured and/or determined indices within the encoder input vector. For instance, the configuration may indicate the mapping order of most significant to least significant RQ indicator element, where the most significant RQ indicator element may be mapped to the lowest index in the configured or determined index list. In another example, the mapping order may be from the least significant to the most significant RQ indicator element, where the least significant RQ indicator element is mapped to the lowest index in the determined index list.

In some examples, the WTRU may be configured with the following. For example, the WTRU may be configured with a compression mode. The WTRU may be configured with the mode for CSI compression where the mode determines whether only CSI or CSI & RQ indicators may be compressed. When only CSI is compressed, RQ indicators are feedback independent of the CSI compression (e.g., RQ indicators are not in the input vector of encoder). The WTRU may be configured with a RQ indicator reporting periodicity. The WTRU may be configured with RQ indicator reporting periodicity by the NW wherein the configuration may include timing indicators and/or a number of reporting slots (e.g., N). The WTRU may be configured with resources for a CSI report. The WTRU may be configured with uplink resources to report the CSI and/or RQ indicators. The WTRU may be further configured for uplink (UL) resources for reporting number of RQ indicators, RQ functions and/or input indices of RQ indicators, if configured to determine and/or report. If the WTRU is configured with CSI only compression mode, then the WTRU may be configured with an uplink resource to report RQ indicators. The WTRU may be configured with loss function for training of the AE. The WTRU may be configured with the loss functions corresponding to CSI and RQ indicator parts. For instance, the WTRU may be configured with separate loss functions for CSI and RQ indicator parts. The WTRU may be configured with loss function weights for the CSI and/or RQ indicator parts that may be used to allocate unequal error protection for CSI and/or RQ indicators. The WTRU may be configured with receive-side (e.g., NW-side) reference decoder. The WTRU may be configured with a NW-side reference decoder and/or a proxy decoder to train the WTRU-side encoder.

In some examples, the WTRU may receive the configuration via radio resource control (RRC) signaling (e.g., RRC configuration). The WTRU may receive the configuration, for instance, upon a change in channel conditions. The WTRU may receive the configuration upon a change in the Tx configuration. The WTRU may receive the configuration upon a handover to a new cell.

WTRU training the WTRU-side encode may be implemented. One or more methods may be described in terms of an encoder and/or decoder of an autoencoder architecture. However, the methods described may be more generally applicable to any type of AI/ML model architecture. For example, the term WTRU-side AI/ML model may be used synonymously with WTRU-side autoencoder. The term NW-side reference decoder may be used interchangeably with proxy decoder. For example, the WTRU may train its AI/ML encoder with the NW-side reference decoder, such that the AI/ML encoder may satisfy one or more interoperability conditions.

In some examples, the WTRU-side AI/ML model may be configured with a proxy decoder (e.g., a reference decoder) that may have been trained to reconstruct the CSI and redundancy elements jointly. The WTRU may train an encoder model, E_{UE}, with the reference decoder, Dref, to minimize the reconstruction loss of both the input CSI (e.g., channel matrix) and the redundancy elements, Y. The loss function may be computed as the sum of two distance metrics or similarity metrics L_{CSI}(.) and L_{UE}(.) which may be L2 distance, cosine similarity, Normalized Mean Square Error, Squared Generalized Cosine Similarity, KL-divergence etc. The overall loss may be constructed as follows:

$${L}_{CSI} ( X , {D}_{ref} ( {E}_{UE} ( X ) ) ) + β {L}_{RQ} ( Y , {D}_{ref} ( {E}_{UE} ( Y ) ) )$$

Where the first term in the loss function L_{CSI}(.) deals with the reconstruction error of the input CSI vector, X, and the second term L_{RQ}(.) deals with the reconstruction error of the redundancy elements, Y. The second term may be thought of as a regularization term, where parameter, β, weights the importance of the reconstructing the redundancy elements, Y. For example, when, β=0, the reconstruction quality of the redundancy elements does not impact the overall loss, so the autoencoder may be trained to optimize the generation and reconstruction of only the CSI vector, X. This parameter may be used to allocate unequal error protection for CSI and redundancy elements, Y. In another example, the WTRU may assign different weights, βᵢ, to different RQ indicator indices in the regularization term.

In some examples, where the WTRU may be configured to compress the CSI vector and redundancy vector jointly, the WTRU may train AI/ML model while incorporating the estimated reconstruction quality in the loss function:

$${L}_{CSI} ( X , {D}_{ref} ( {E}_{UE} ( X ) ) ) + β {L}_{RQ} ( F ( {X}^{′} ) , {Y}^{′} )$$

In some examples, the WTRU-side AI/ML model may be configured with a proxy (e.g., reference) decoder that may have been trained to reconstruct only the CSI vector and not the redundancy elements. The WTRU may train an encoder model, E_{UE}, with the reference decoder, D_{ref}, to compress and reconstruct the CSI only and not the RQ vector. In this case the WTRU may still report the uncompressed RQ indicators through a legacy control channel. The WTRU may train its AI/ML encoder with the NW-side proxy decoder to minimize the reconstruction loss and additionally regularize the training to ensure the reconstruction preserves the functional mapping of X to the redundancy elements, Y=F(X). The loss function may be constructed as follows:

$${L}_{CSI} ( X , {D}_{ref} ( {E}_{UE} ( X ) ) ) + β {L}_{RQ} ( F ( X ) , F ( {X}^{′} ) )$$

where X′=D_{ref}(E_{UE}(X)). The WTRU may ensure that the trained WTRU-side encoder model, E_{UE}, is compatible with the full NW side decoder, D_{NW}, by checking that the intermediate key performance indicators (KPIs) are at and/or below the configured threshold(s). For example, the WTRU may receive separate thresholds for the reconstruction accuracy of X and Y. In another example the WTRU may receive a single threshold value for the joint reconstruction accuracy of X and Y.

The WTRU computing the CSI RQ indicators may be implemented. A WTRU capable of generating RQ indicators may receive reference signals (e.g., CSI-RS) to measure the channel. As an example, the measured channel X can be of size Nᵣ. Nₜ. N_{c}, where Nₜ represents number of transmit antennas, Nᵣ represents the number of receive antennas, and N_{c} represents the number of sub-bands. The WTRU may also apply pre-processing to the channel vector if configured (e.g., WTRU may obtain eigenvectors for the channel matrix). For instance, the RQ indicators may occupy some of the entries of the input vector of the encoder.

In some examples, the WTRU may determine the number of RQ indicators based on one or more of the following. For example, the WTRU may determine the number of RQ indicators to improve the performance of estimation of reconstruction quality. The WTRU may determine the number of RQ indicators to reduce the impact of replacing some entries of the input vector with RQ indicators. For instance, the WTRU may determine the number of RQ indicators based on the configuration from the NW. If the WTRU is configured with a fixed number of RQ indicators, then the WTRU may determine the number of RQ indicators based on the configuration.

For instance, if the WTRU is configured to determine and report the number RQ indicators, then the WTRU may determine the number of RQ indicators based on one or more of the following. For example, the WTRU may determine the number of RQ indicators based on channel quality. For instance, the WTRU may use the SNR of the feedback channel and determine the number of RQ indicators. In some examples, if the uplink SNR is smaller than a threshold, the WTRU may select a larger number of RQ indicators. In some examples, if the uplink SNR is larger than a threshold, then the WTRU may select a smaller number of RQ indicators. The high and/or low values for the number of RQ indicators may be configured. For instance, the WTRU may use a look-up table to determine the number of RQ indicators based on the uplink SNR.

The WTRU may determine the number of RQ indicators based on the statistical metrics of the measured CSI. For example, the WTRU may compute whether the measured CSI is in-distribution, out-of-distribution and/or determine the number of RQ indicators. In some examples, if the measured CSI is in-distribution, then the WTRU may select a high value for the number of RQ indicators. In some examples, if the measured CSI is out-of-distribution, then the WTRU may select a low value for the number of RQ indicators. For example, in-distribution may refer to the case where the distribution of measured CSI is similar to the distribution of the CSI dataset used in the training of the autoencoder. For example, out-of-distribution may refer to the case where the distribution of measured CSI is different from the distribution of the CSI dataset used in the training of the autoencoder. In another example, the WTRU may use a look-up table to determine the number of RQ indicators based on the similarity of distributions.

The WTRU may determine the number of RQ indicators based on the performance monitoring metrics of the compression model. For example, the WTRU may use intermediate KPIs (e.g., SGCS and/or NMSE) measured and/or estimated by the WTRU and/or indicated by the NW. The WTRU may select a value for the number of RQ indicators based on the intermediate KPI metrics.

In some examples, the WTRU-side encoder may have fixed input vector size. The WTRU may apply dimension reduction to measured CSI prior the compression based on the determined number of RQ indicators. For example, the WTRU may truncate m symbols from the input CSI given that the determined number of RQ indicators is m. For example, the WTRU may down-sample the measured CSI by a decimation factor of (N−m)/N, given that the number of RQ indicators is m and the size of measured CSI vector is N.

In some examples, the WTRU may compute the RQ indicators based on the determined number of RQ indicators and the configured RQ functions. For example, an RQ function F(.) may be a set of linear combinations of measured CSI values. For instance, a linear transformation Y=F(X)=AX, where Y denotes the RQ indicators, matrix A denotes the linear transformation matrix, and X denotes the input CSI vector (and/or matrix). For example, if the WTRU is configured with a single RQ function (e.g., single F(.) or single A), then the WTRU may compute one set of RQ indicators (e.g., only one Y vector, of size m, where m represents the determined number of RQ indicators (e.g., size of vector Y)). For example, if the WTRU is configured with a set of (e.g., more than one) RQ functions (e.g., {F₁(.), . . . , Fₖ(.)} or {A₁, . . . , Aₖ} where k denotes the number of RQ functions), the WTRU may compute k RQ indicators (e.g., {Y₁, . . . , Yₖ} where Yᵢ=Fᵢ(X)=AᵢX.

In some examples, the WTRU may select the RQ function (and/or the RQ indicators) based on one or more of the following. For example, the WTRU may select the RQ function to improve the performance of estimation of reconstruction quality. For example, the WTRU may select the RQ function to reduce the impact of replacing some entries of the input vector with RQ indicators. For instance, the WTRU may compare the distribution of the RQ indicators Yᵢ with measured CSI X and selects the RQ function index i* (and/or the RQ indicator index) so that the similarity of the distribution of Y_{i*} and X is the highest. In order to measure the similarity of the distributions, sample probability distribution distance metrics may be used (e.g., Chi-squared distance, Kullback-Leibler divergence, etc.). For instance, the WTRU may compute the maximum and minimum values of the RQ indicators Yᵢ and checks whether they fall within the specific percentiles of the CSI training data (e.g., the minimum value of Yᵢ must not be in the k-th quartile, and the maximum value of Yᵢ must be in the (100-k)th quartile). The RQ indicator Yᵢ (or the RQ function Fᵢ(.)) that satisfies this constraint may be selected. For instance, the WTRU may select the RQ function (or the corresponding RQ indicator Yᵢ) so that the input vector to the encoder consisting of concatenated CSI vector X and Yᵢ demonstrates the highest continuity at the encoder input. For example, the WTRU may compute the mean absolute differences of X (i.e., Dₓ) and the mean absolute differences of [X, Yᵢ], (e.g., D_{X,Yi}) and selects the Yᵢ that results in minimum change in mean absolute differences |D_{X}-D_{X,Yi}|.

The WTRU determining the input indices of CSI RQ indicators may be implemented. In some examples, the input data may consist of the joint payload and RQ indicators. For example, for AI/ML CSI compression using AE, when the WTRU may be configured for joint CSI and RQ compression, the data at the AI/ML encoder input (e.g., the encoder input vector) may consist of the measured CSI and the calculated RQ indicators.

In some examples, the WTRU may save the calculated RQ indicator(s) in fixed locations within the encoder input vector (e.g., when the WTRU receives the configuration for the RQ indicator(s) input indices), where the fixed index locations may be as follows. For instance, the fixed index locations may be contiguous, appended to the end of the input CSI vector. The fixed index locations may be contiguous, prepended at the beginning of the input CSI vector. The fixed index locations may be contiguous, from the configured start index to the configured end index within the encoder input vector. The fixed index locations may not be contiguous, in the configured locations within the encoder input vector. The WTRU may save the calculated RQ indicator(s) in the configured locations within the encoder input vector in the configured mapping order, for example, mapping the most significant RQ indicator to the lowest index in the configured list of indices, and/or mapping the least significant RQ indicator to the lowest index in the configured list.

In some examples, the WTRU may determine the RQ indicator(s) input indices, for example, when the WTRU is configured with a RQ function and is enabled to determine the RQ indicator(s) input indices.

For example, the WTRU may determine the RQ indicator(s) input indices such that the continuity of the encoder input vector (e.g., the continuity of the joint input CSI and calculated RQ indicator(s)) may be preserved, where the continuity may be in terms of the magnitude of the encoder input vector elements, the phase of the encoder input vector elements and/or both the magnitude and phase. For instance, the WTRU may preserve the magnitude continuity. For each element of the calculated RQ indicators, the WTRU may determine the index in the CSI input vector such that the magnitude of the current RQ indicator element is in the range defined by the magnitudes of adjacent CSI elements at the determined CSI index. For instance, the WTRU may preserve the phase continuity. For each element of the calculated RQ indicators, the WTRU may determine the index in the CSI input vector such that the phase of the current RQ indicator element is in the range defined by the phases of adjacent CSI elements at the determined CSI index. In some examples, the WTRU may insert the RQ indicator elements at the determined indices between consecutive CSI input elements, for example when the WTRU-side AI/ML encoder model input size equals the input CSI vector size plus the RQ indicator(s) size. In some examples, the WTRU may puncture the CSI input vector at the determined indices and replace the CSI input elements at those locations with the calculated RQ indicator elements, for example, when the WTRU-side AI/ML encoder model input size equals the input CSI vector size. In this example, the WTRU may report both the determined RQ indicator(s) input indices and a puncturing indicator (e.g., flag). The receive-side (e.g., NW-side) may use the puncturing flag to recover the punctured CSI elements, for example using interpolation.

In some examples, the WTRU may determine the RQ indicator(s) input indices as a function of the active WTRU-side AI/ML encoder model. For example, the WTRU may map the calculated RQ indicator(s) to the RQ part of the encoder input vector, when the encoder model is configured with separate loss functions for the input CSI and the RQ indicators parts, and/or when the encoder model was trained to provide unequal error protection for the input CSI and the RQ indicators parts. In some examples the WTRU may be configured to jointly select the RQ function and the RQ indicator(s) encoder input vector indices (e.g., to preserve the continuity of the encoder input vector).

In some examples, the input data may consist of the payload only, while the calculated RQ indicators may be transmitted separately. For example, for AI/ML CSI compression using AE, when the WTRU is configured for CSI only compression, the data at the AI/ML encoder input may consist of the measured CSI.

The calculated RQ indicators may be compressed separately from the input payload and/or may be reported uncompressed. For instance, when the RQ indicators are compressed separately, the WTRU may compress the calculated RQ indicator(s) separately from compressing the input CSI, for example when the WTRU is configured with a dedicated RQ indicator(s) encoder. For instance, when the RQ indicators are reported uncompressed, the WTRU may quantize the RQ indicators (e.g., using a scalar quantizer), for example, when the WTRU is configured to report uncompressed RQ indicator(s). The WTRU may select the number of quantization bits as a function of a configured maximum quantization error for the RQ indicators (e.g., such that the actual RQ indicator quantization error is smaller than a configured threshold).

Feedback of CSI RQ indicators may be implemented. In some examples, a WTRU may be configured to report the RQ indicators to enable estimation of reconstructed CSI quality at the receive-side. In some examples, the WTRU may be configured to compress the RQ indicators jointly with the CSI. In some examples, the WTRU may be configured to separately compress the CSI and the RQ indicators. In some examples, the WTRU may be configured to compress only the CSI, and then report the compressed CSI and the uncompressed RQ indicator.

A WTRU may transmit the RQ indicators. In some examples, the WTRU may perform one or more of the following. For example, the WTRU may perform a transmission of a single CSI report if the CSI and the RQ indicators are jointly compressed. The WTRU may transmit the RQ indicators as a part of the CSI report. The WTRU may be configured to transmit the CSI report through uplink control information (UCI) over physical uplink control channel (PUCCH), or physical uplink shared channel (PUSCH). For example, the WTRU may perform a transmission of RQ indicators separate from the compressed CSI. The WTRU may be configured to report the RQ indicators through UCI over PUCCH, or PUSCH. The transmission may cover the full bandwidth, or a part of it. The transmission may be periodic, semi-persistent, or aperiodic. For example, the WTRU may be configured to transmit the RQ indicators every time a CSI report is transmitted. In some examples, the WTRU may be configured to report the RQ indicators every N slots. For example, the WTRU may be configured and/or triggered to transmit the RQ indicators upon the NW request (e.g., via downlink control information (DCI) or medium access control (MAC) control element (CE)).

In some examples, a WTRU may be configured to report the determined parameters of RQ indicators. For example, a WTRU may report one or more of the following parameters, if it is configured or triggered to report them. For instance, the WTRU may report the number of RQ indicators determined by the WTRU. The WTRU may report the RQ function if selected or determined by the WTRU. The WTRU may report WTRU-determined RQ indicators input indices. The WTRU may report other parameters related to RQ indicators, if they are determined by the WTRU (e.g., compression mode (joint or separate), puncturing flag (which indicates whether the WTRU performed puncturing of the input CSI vector to generate the encoder input vector).

In some examples, the WTRU may be configured to report determined parameters of RQ indicators and other information through UCI over PUCCH, or PUSCH. The WTRU may be configured and/or triggered to report determined parameters of RQ indicators and other information periodically, semi-persistently, or aperiodically. For example, the WTRU may be configured to report determined parameters of RQ indicators and other information along with a CSI report. In another example, the WTRU may be configured to report determined parameters of RQ indicators and other information, along with the RQ indicator, if the RQ indicator is reported in a different periodicity than the compressed CSI. In another example, the WTRU may be configured to report determined parameters of RQ indicators and other information upon request from the NW (e.g., via DCI or MAC CE). The WTRU may be configured to report determined parameters of RQ indicators and other information through UCI over PUCCH, or PUSCH. In some examples, the determined parameters of RQ indicators and other information may be configured to be reported via the same physical uplink channel as the CSI report and/or the RQ indicators. In some examples, the WTRU may be configured to report them via a different physical uplink channel than the CSI report and the RQ indicators.

Estimation of CSI RQ at the NW may be implemented. For example, upon receiving the feedback associated with CSI RQ indicators, the NW may reconstruct (e.g., using an AI/ML decoder model) the received CSI along with the RQ indicators, based on the indicated position indices. For instance, the NW may only reconstruct the CSI using an AI/ML decoder model, and receive the RQ indicator separately (e.g., non-compressed) either on a separate channel and/or on the same channel as the CSI. In another example, the NW may jointly decompress the received CSI and the RQ indicators.

In some examples, the reconstructed CSI may be denoted as X′ and the reconstructed RQ indicator be denoted as Y′. The NW may determine the RQ by comparing the reconstructed RQ indicator, Y′, with the RQ indicator calculated based on the reconstructed CSI X′ (e.g., F(X′)) wherein the reconstruction function F(.) is known by the NW, either originally configured by the NW and/or determined and/or signaled to the NW by the WTRU. Under ideal conditions (e.g., perfect reconstruction of Y′ and X′) Y′ may be equal to F(X′), implying that the reconstruction quality of the CSI may be high. In other examples, when there may be many errors in the reconstruction of X′, then the difference between Y′ and F(X′) may be high, implying that the reconstruction of the CSI may be poor. To determine whether the gap between Y′ and F(X′) is acceptable or not, the NW may measure a metric of Y′ and F(X′) and compare it against one or more thresholds. For example, the metric may be the NMSE between F(X′) and Y′ and is defined as:

$$NMSE = \frac{{‖ F ( {X}^{′} ) - {Y}^{′} ‖}^{2}}{{‖ F ( {X}^{′} ) ‖}^{2}} .$$

In some examples, the metric may be the difference between F(X′) and Y′ defined as:

$$D = {‖ F ( {X}^{′} ) - {Y}^{′} ‖}_{1}$$

where ∥.∥₁ is the L1-norm. In some examples, the metric may be the cosine similarity between Y′ and f(X′), defined as,

$$SGCS = \frac{\vert {Y}^{′ T} F ( {X}^{′} ) \vert}{{‖ {Y}^{′} ‖}^{2} {‖ F ( {X}^{′} ) ‖}^{2}} .$$

The NW may decide on the quality of the reconstructed CSI based on the computed value of the metric. For example, the NW may compare the resulting metric with a threshold to determine whether the performance is acceptable or not. In some examples, the NW may compare the computed metric with multiple thresholds to determine the level of the reconstruction quality and the required action associated with each metric.

In some examples, the NW may take one or more actions based on the outcome of comparing the measured metric with the threshold. For example, the NW may decide a model failure if the number of instances where the RQ is poor exceeds a certain threshold. For example, the NW may request a change in the function associated with the RQ if the RQ is poor.

In some examples, the WTRU may receive one or more indications based on the NW estimation of the reconstructed quality. For example, the indications may include one or more of the following. For instance, the indications may include a change of the function used for reconstruction quality indicators. The indications may include and update to the allocation of the function (e.g., add higher protection and/or allocation to the feedback associated with the function). The indications may include an update to the position indices associated with the function. The indications may include fallback to legacy reporting. The indications may include an increase and/or decrease to the payload size of the AI/ML mode in case the quality is below or above a threshold. The indications may include a switch to a different AI/ML model configured by the NW.

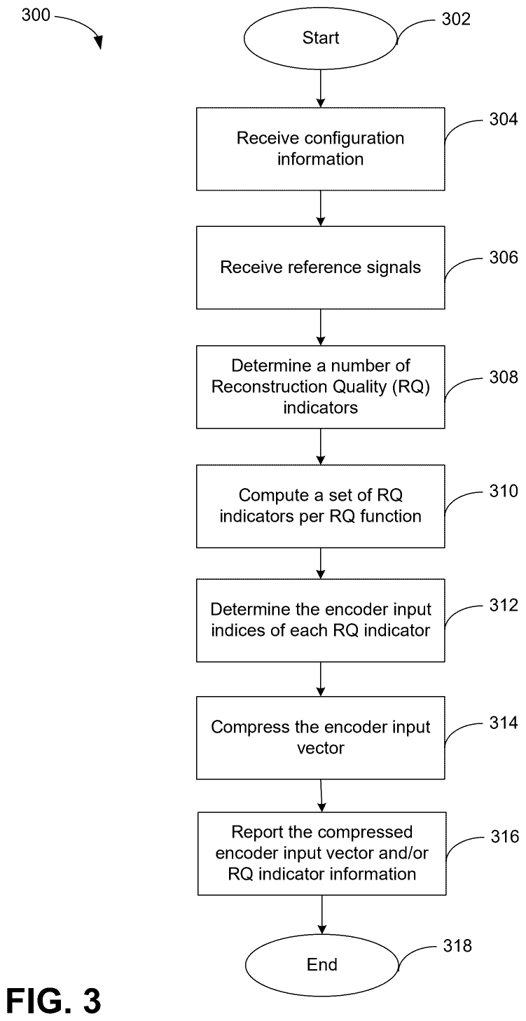

FIG. 3 is an example of a procedure 300 for estimation of CSI RQ. The procedure 300 may be performed by a WTRU. The procedure 300 may be started at 302. At 304, the WTRU may receive configuration information. The configuration may include one or more parameters associated with the estimation of CSI reconstruction quality, where the configuration may include one or more of the following. For example, the configuration may include a number of RQ indicators (e.g., fixed number of RQ indicators). The WTRU may determine and/or report the number of RQ indicators. The configuration may include one or more RQ function(s) to compute CSI RQ indicators based on the measured CSI values (e.g., indication of a single function to compute the RQ indicators and/or indication of more than one function for the WTRU to select and report a function). The configuration may include input indices of RQ indicators. For instance, the input indices of RQ indicators may include exact indices of the RQ indicators within the encoder input vector (e.g., input indices). The input indices of RQ indicators may include where the encoder input vector is composed of a CSI input vector possibly multiplexed with a set of one or more RQ indicator(s). The WTRU may determine and report the input indices. The configuration may include reporting periodicity for the RQ indicator (e.g., every N reporting). The configuration may include resources to report the compressed CSI, RQ indicators and/or input indices. The configuration may include compression mode, where the mode may determine whether only CSI or CSI & RQ indicators are compressed.

At 306, the WTRU may receive reference signals to measure and/or predict the input CSI vector. At 308, the WTRU may determine the number of RQ indicators based on one of the following. For example, the WTRU may determine the number of RQ indicators based on the configuration from the NW. If configured by the NW to determine and report the number of RQ indicators, the WTRU may determine the number of RQ indicators based on the channel quality, where the WTRU may select a higher number of RQ indicators for low signal-to-noise ratio (SNR). If configured by the NW to determine and report the number of RQ indicators, the WTRU may determine the number of RQ indicators based on the statistical properties of the CSI, where the WTRU may select a higher number of RQ indicators if the current CSI is out of distribution (OOD). The WTRU may truncate and/or down sample the input CSI vector X based on the determined number of RQ indicators.

At 310, the WTRU may compute a set of RQ indicators per RQ function, using the one or more RQ function(s), and may select a set of RQ indicators and associated RQ function. For instance, the selection of a set of RQ indicators and associated RQ function may be based on the determined number of RQ indicators and the configured single function to determine the RQ indicators. The selection of a set of RQ indicators and associated RQ function may be based on the determined number of RQ indicators and the configured set of functions to determine the RQ indicators. The selection of a set of RQ indicators and associated RQ function may be based on preserving the statistical properties of input CSI vector (e.g., the set of RQ indicators are in-distribution and/or the set of RQ indicators are within the range of input CSI vector elements). If the WTRU is configured with fixed input indices for the set of RQ indicators (e.g., within the input vector of the encoder), the WTRU may select the RQ function such that set of RQ indicators may not cause discontinuity and/or significant discontinuity at the encoder input.

At 312, the WTRU may determine the encoder input indices of each RQ indicator. For example, the WTRU may determine the input indices based on the configuration from the NW (e.g., fixed input indices configured by the NW). If the WTRU is configured with a RQ function, the WTRU may determine the input indices for RQ indicators (e.g., so that the encoder input vector preserves continuity). In some examples, if the WTRU is configured with a set of RQ functions and configured to determine the encoder input vector indices, the WTRU may jointly select RQ function and RQ indicators encoder input vector indices (e.g., so that the encoder input vector preserves continuity).

At 314, the WTRU may compress the encoder input vector. In some examples, the encoder input vector consists of only the input CSI vector. In some examples, the encoder input vector consists of the input CSI vector and one or more RQ indicators.

At 316, the WTRU may report one or more of the compressed encoder input vector and/or the information on the RQ indicators. For example, the WTRU may report the uncompressed RQ indicators. For example, the WTRU may report an indication that the encoder input vector consists of only the input CSI vector, and/or consists of input CSI vector and one or more RQ indicators. For example, the WTRU may report a RQ indicator parameter. For instance, the WTRU may report the number of RQ indicators, RQ function, and/or the encoder input vector indices of the RQ indicators. The procedure 300 may end at 318.

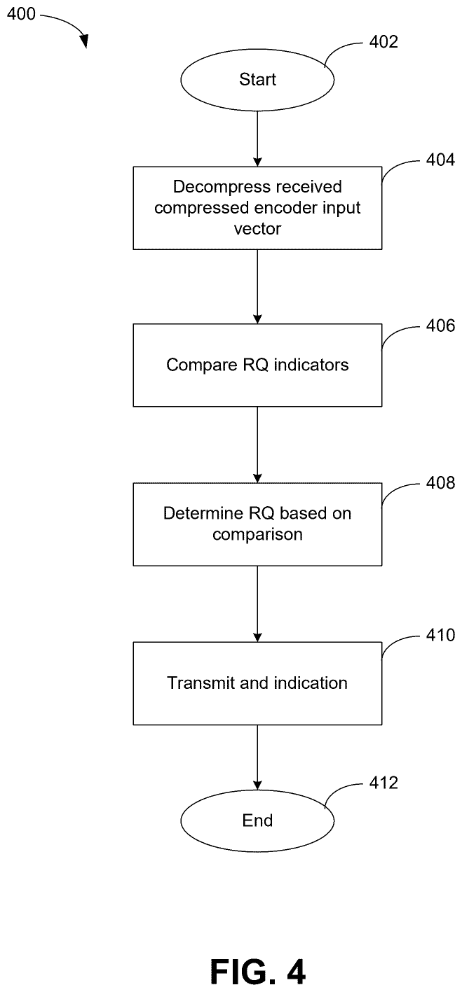

FIG. 4 is an example of a procedure 400 for estimation of CSI RQ at the receiving node (e.g. WTRU or NW). The procedure 400 may be performed by a WTRU or NW. The procedure 400 may be started at 402. At 404, the receiving node may decompress the received compressed encoder input vector and may determine a reconstructed output CSI vector and reconstructed RQ indicators. At 406, the receiving node may compare the reconstructed RQ indicators (Y′) with the receiver-side RQ indicators created using the reconstructed output CSI vector, X′, and the known RQ function (e.g., F(X′)). At 408, the receiving node may determine the reconstructed quality based on a comparison (e.g., via computing a distance metric Dist(Y′,F(X′)). At 410, the receiving node may transmit an indication based on the determined reconstruction quality. For example, the receiving node may transmit an indication to fallback to non-AI/ML reporting in case the quality below threshold. The receiving node may transmit an indication to increase payload size of compressed encoder input vector in case the quality is below threshold. The procedure 400 may end at 412.

1. A wireless transmit/receive unit (WTRU) comprising:
a processor configured to:
receive configuration information, wherein the configuration information comprises a first reconstruction quality (RQ) function and a second RQ function;
determine a channel state information (CSI) based on a plurality of reference signals (RSS);
determine a first plurality of RQ indicators for the first RQ function based on the first RQ function;
determine a second plurality of RQ indicators for the second RQ function based on the second RQ function;
select the first plurality of RQ indicators or the second plurality of RQ indicators based on the CSI;
determine encoder input indices for each RQ indicator of the selected plurality of RQ indicators;
generate a compressed encoder input information-vector based on the determined encoder input indices, selected plurality of RQ indicators, and determined CSI; and
send the compressed encoder input vector and information relating to the selected plurality of RQ indicators.

2. The WTRU of claim 1, wherein the configuration information comprises an indication of a number of RQ indicators; and
wherein the processor is configured to select the first plurality of RQ indicators or the second plurality of RQ indicators based on the number of RQ indicators indicated by the configuration information.

3. The WTRU of claim 2, wherein the indication of the number of RQ indicators comprises a fixed number.

4. The WTRU of claim 2, wherein the indication of the number of RQ indicators comprises an indication that the WTRU is to determine the number of RQ indicators based on a quality of a channel or based on a statistical property of channel state information (CSI) associated with downlink reference signals (RSs).

5. The WTRU of claim 1, wherein the configuration information comprises information associated with the encoder input indices; and
wherein the processor is configured to determine the encoder input indices based on the information associated with the encoder input indices, and wherein the information associated with the encoder input indices comprises fixed encoder input indices.

6. (canceled)

7. The WTRU of claim 5, wherein the information associated with the encoder input indices comprises an indication that the WTRU is to determine the encoder input indices.

8. The WTRU of claim 1, wherein the compressed encoder input information comprises a compressed encoder input vector, and wherein the compressed encoder input vector comprises the CSI and one or more RQ indicators.

9. The WTRU of claim 1, wherein the configuration information further comprises one or more of a fixed number of RQ indicators, a reporting periodicity for the RQ indicators, or a compression mode, and wherein the compression mode is determined based on whether CSI is compressed, or CSI and RQ indicators are compressed.

10. (canceled)

11. A method performed by a wireless transmit/receive unit (WTRU), the method comprising:
receiving configuration information, wherein the configuration information comprises a first reconstruction quality (RQ) function and a second RQ function;
determining a channel state information (CSI) based on a plurality of reference signals (RSs);
determining a first plurality of RQ indicators for the first RQ function based on the first RQ function;
determining a second plurality of RQ indicators for the second RQ function based on the second RQ function;
selecting the first plurality of RQ indicators or the second plurality of RQ indicators based on the CSI;
determining encoder input indices for each RQ indicator of the selected plurality of RQ indicators;
generating a compressed encoder input information-vector based on the determined encoder input indices, selected plurality of RQ indicators, and determined CSI; and
sending the compressed encoder input vector and information relating to the selected plurality of RQ indicators.

12. The method of claim 11, wherein the configuration information comprises an indication of a number of RQ indicators; and
wherein the method comprises selecting the first plurality of RQ indicators or the second plurality of RQ indicators based on the number of RQ indicators indicated by the configuration information.

13. The method of claim 12, wherein the indication of the number of RQ indicators comprises a fixed number.

14. The method of claim 12, wherein the indication of the number of RQ indicators comprises an indication that the method comprises determining the number of RQ indicators based on a quality of a channel or based on a statistical property of channel state information (CSI) associated with downlink reference signals (RSs).

15. The method of claim 11, wherein the configuration information comprises information associated with the encoder input indices; and
wherein the method comprises determining the encoder input indices based on the information associated with the encoder input indices, and wherein the information associated with the encoder input indices comprises fixed encoder input indices.

16. (canceled)

17. The method of claim 15, wherein the information associated with the encoder input indices comprises an indication that the method comprises determining the encoder input indices.

18. The method of claim 11, wherein the compressed encoder input information comprises a compressed encoder input vector, and wherein the compressed encoder input vector comprises the CSI and one or more RQ indicators.

19. The method of claim 11, wherein the configuration information further comprises one or more of a fixed number of RQ indicators, a reporting periodicity for the RQ indicators, or a compression mode, and wherein the compression mode is determined based on whether CSI is compressed, or CSI and RQ indicators are compressed.

20. (canceled)

21. The WTRU of claim 1, wherein the processor is further configured to:
determine the first plurality of RQ indicators based on the first RQ function and the CSI; and
determine the second plurality of RQ indicators based on the second RQ function and the CSI.

22. The WTRU of claim 1, wherein the processor is further configured to:
compress the selected plurality of RQ indicators and the CSI, wherein the information relating to the selected plurality of RQ indicators comprises the selected plurality of RQ indicators and the CSI.

23. The method of claim 11, wherein the processor is further configured to:
determine the first plurality of RQ indicators based on the first RQ function and the CSI; and
determine the second plurality of RQ indicators based on the second RQ function and the CSI.

24. The method of claim 11, wherein the processor is further configured to:
compress the selected plurality of RQ indicators and the CSI, wherein the information relating to the selected plurality of RQ indicators comprises the selected plurality of RQ indicators and the CSI.
